(19) United States
(12) Patent Application Publication
(10) Pub. No.: US 2009/0079670 A1
(43) Pub. Date: Mar. 26, 2009

(54) DISPLAY DEVICE

(75) Inventor: Adrianus Sempel, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,255

(22) PCT Filed: Oct. 28, 2005
(86) PCT No.: PCT/IB05/53524

§ 371 Date: Apr. 30, 2007

(30) Foreign Application Priority Data
Nov. 3, 2004 (EP) 04105468.5

(51) Int. Cl. G09G 3/12

(52) U.S. Cl. 345/45

(57) ABSTRACT

The use of a resistive or capacitive voltage-current-converter (35) in an (active addressed matrix) luminescent display pixel circuit allows fast programming and highly accurate pixel current definition for improved display uniformity.

The invention relates to a display device comprising pixels at the area of crossing electrodes, each pixel comprising at least a current adjusting circuit based on a memory element, a connection point of the adjusting circuit being connectable in series with a luminescent element.

Such electroluminescence-based display devices are increasingly based on (polymer) semiconducting organic materials, semiconducting anorganic materials or electro luminescent materials. The display devices may either luminesce via segmented pixels (or fixed patterns) but also display by means of a matrix pattern is possible. The adjustment of the pixels via the memory element determines the intensity of the light to be emitted by the pixels. Said adjustment by means of a memory element, in which extra switching elements are used (so-called active drive) finds an increasingly wider application.

Suitable fields of application of the display devices are, for example, mobile telephones, organizers, etc.

A display device of the type described in the opening paragraph is described in PCT WO 0191095. In said document, the current through a luminescent device is adjusted by means of individual TFT transistor circuits per pixel in a matrix of luminescent pixels. To this end, a charge is produced across a capacitor via a branch of two TFT transistors a connection point of the adjusting circuit being connectable in series with a luminescent element and. A further TFT transistor and the capacitor constitute a memory element.

After the first TFT transistors have been turned off, the charge of the capacitor determines the current through the further TFT transistor and hence the current through the luminescent device. At a subsequent selection, this is repeated.

This way of driving is called current programming and allows a fundamentally more accurate way to define the transistor output current than voltage programming in which the input-data voltage signal is stored on a capacitor. An output transistor converts this voltage into a current to drive the luminescent element during the display phase. A drawback is the accuracy of the derived output current. Spread in TFT transistor threshold voltage and carrier mobility severely limits this accuracy.

In current programming however, a drawback is the limited speed possible for the programming phase. The small current is injected to the pixel via a long column line with its inherent large parasitic capacitance. When the pixel circuit consists of a so-called rationed current mirror, the input transistor is made larger than the output transistor. This allows an up scaling of the data-input current, while the output current is sufficiently low to drive the luminescent element. The high data-input current indeed increases the programming speed of the pixel circuit but, this now relies on the matching of the two mirror transistors which again limits the current accuracy especially for the low current levels at the lowest luminance levels.

In PCT WO 0191095 (so-called switched-mirror approach) only one transistor is used both for defining the stored capacitor voltage directly related to the input current, and in a next period to deliver an identical pixel output current. As the same transistor is used in both time periods, transistor spread is largely avoided. This method however allows no current scaling between the two time periods. As a result the programming time needs to be long enough to assure that the parasitic column capacitance is fully charged, before the correct column data-input current flows into to pixel transistor.

It is, inter alia, an object of the present invention to provide a display device of the type described in the opening paragraph in which the above-mentioned problems occur to a lesser extent.

To this end, such a display device comprises voltage-current converting means at the area of a pixel for adjusting current through the luminescent element between a column electrode and a connection point of the memory element.

By giving each pixel an accurate voltage-to-current converter the input voltage, constant during the programming phase time, is converted into a current. This current now is stored in e.g. a switched current mirror. After the programming phase, the switched mirror is connected into the output mode to deliver the programmed current into the pixel.

The simplest way of converting consists in using a single resistor. However, resistors or transistors used as resistor show spread.

Therefore a preferred embodiment of the invention uses a capacitor as a voltage-to-current converter. This is possible when the input voltage varies during the programming phase. For instance with a triangle ramp voltage the current in a column electrode follows from:

Q=C×V=I×t→I=C×dV/dt

where dV/dt describes the voltage ramp during programming.

The advantage is that capacitors can be made with better accuracy than transistors. In this way a better display uniformity is obtained.

These and other aspects of the invention are apparent from and will be elucidated with reference to the embodiments described hereinafter.

In the drawings:

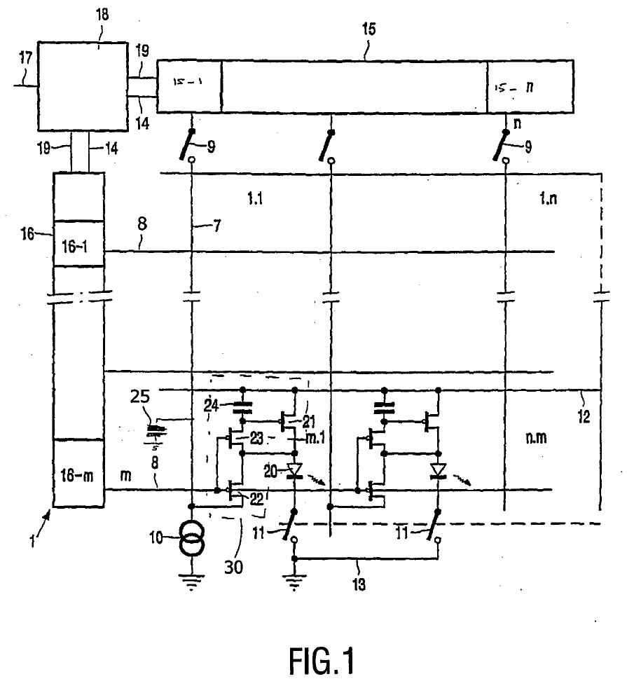

FIG. 1 shows diagrammatically a display device according to the prior art,

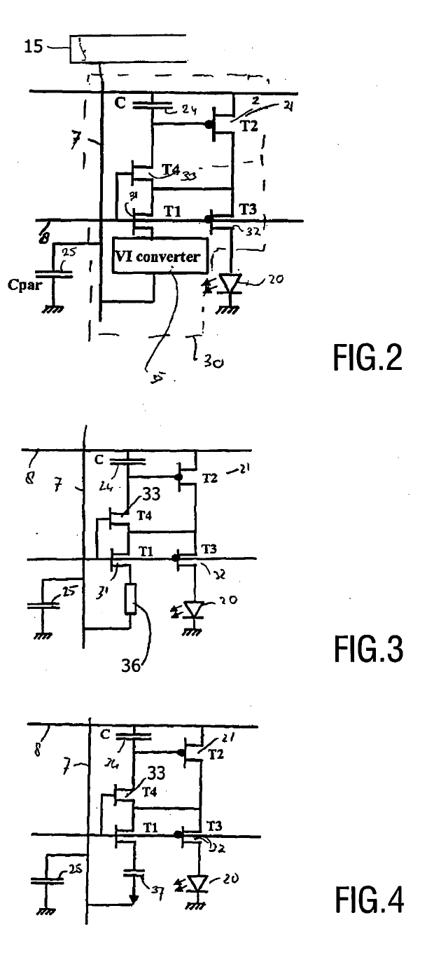

FIG. 2 shows a part of a device according to the invention, while

FIG. 3 shows a possible embodiment of FIG. 2 and

FIG. 4 shows a further embodiment.

The Figures are diagrammatic; corresponding components are generally denoted by the same reference numerals.

FIG. 1 shows diagrammatically an equivalent circuit diagram of a part of a display device 1 according to the invention. This display device comprises a matrix of (P) LEDs or (0) LEDs 20 with n lines or rows 8 (1, 2, . . . , m) and m columns 7 (1, 2, . . . , n). Where rows and columns are mentioned, they may be interchanged, if desired. This device further comprises a row selection circuit 16 and a data register 15. Externally presented information 17, for example, a video signal, is processed in a processing unit 18 which, dependent on the information to be displayed, charges the separate parts 15-1, . . . , 15-n of the data register 15 via supply lines 19.

The selection of a row takes place by means of the row selection circuit 16 via the lines 8, in this example, gate electrodes of TFT transistors or MOS transistors 22, by providing them with the required selection voltage.

Writing data in this prior art device takes place via current programming, which means that, during selection, the current source 10, which may be considered to be an ideal current source, is switched on by means of the data register 15, for example, via switches 9. The value of the current is determined by the contents of the data register. The current source 10 generally is common to a plurality of rows.

During addressings, the capacitor 24 is provided with a certain charge via the transistors 21, 22 and 23. This capacitor determines the adjustment of the transistor 21 (and constitutes said memory circuit therewith) and hence the actual current through the LED 20 during the drive period, and the luminance of (in this example) the pixel (n, 1), as will be described hereinafter. Mutual synchronization between the selection of the rows 8 and the presentation of voltages to the columns 7 takes place by means of the drive unit 18 via drive lines 14. The capacitor 24 together with the transistors 21, 22 and 23 is considered as the pixel driving circuit 30.

At the instant when a row, in this example row 1, is selected, the current source 10 starts to convey current. During selection, information is presented from column register 15 (in this example) via the line 7. This information determines the current through the (adjusting) transistors 21, 22 and 23 so that the capacitor 24 acquires a given charge, dependent on the conveyed current and the period of time. The other plate of the capacitor 24 is connected to the positive power supply line 12. After selection at the end of the programming phase (after closure of the switch 22), this capacitor has a certain charge, which determines the voltage at the gate of (control) transistor 21. The diode (LED) 20 does not start conducting until the pixel has been adjusted, i.e. when the associated transistor 21 has been adjusted in a similar manner. At that instant (which may be at the end of a line time or at the end of a frame time), e.g. a common switch 11 between one or more LEDs 20 and, for example, ground (in this example via the line 13) is closed for a short time so that current can flow through the transistors 21 and the LEDs 20 so that the LEDs luminesce in conformity with the adjusted value.

Current programming fundamentally allows a very accurate way to define output current of the transistor 21. However, a drawback is the limited speed possible for the programming phase. The small current is injected to the pixel via a long column line with its inherent large parasitic capacitance 25.

Up-scaling of the data-input current, while the output current may be kept sufficiently low for driving the organic LEDs is possible by using as a pixel driving circuit a ratio-ed current mirror, in which an input transistor is made larger than the output transistor. The high data-input current increases the programming speed of the pixel circuit. Although it is faster, this way of current programming relies on the matching of the two mirror transistors which again limits the current accuracy especially for the low current levels at the lowest display luminance levels.

A way of increasing the accuracy is the switched-mirror approach, where only one transistor is used both for defining the stored capacitor voltage directly related to the input current (programming phase), and in a next period to deliver (driving phase) an identical pixel output current to the LED 20. As the same transistor is used in both time periods, transistor spread is largely avoided. This method however allows no current scaling between the two time periods. As a result the programming phase needs to be long enough again to assure that the parasitic (column) capacitance 25 is fully charged, before the correct column data-input current flows into the LED.

FIG. 2 shows a part of a device according to the invention. The pixel driving circuit 30 now comprises p-type TFTs 31, 34 (T1, T4) and n-type TFTs 32, 21 (T3, T2) and a capacitor 24. The selection of a row now takes place again by means of the row selection circuit 16 via the lines 8, in this example, gate electrodes of TFT transistors or MOS transistors 31,32,33, by providing them with the required selection voltages. At the same time columns 7 are provided with data voltages.

Although data voltages are presented to the columns 7 writing data in this device nevertheless takes place via current programming by integrating a voltage-current converter 35 in the pixel driving circuit 30. This means that, during selection, the current source 31,33,35 within a pixel driving circuit 30, which may be considered to be an ideal current source, is switched on by means of the data register 15 via a programming data voltage.

The capacitor 24 is provided immediately with a certain charge via the current source 31,33,35 during the programming phase. This capacitor determines the adjustment of the transistor 21 (and constitutes said memory circuit therewith) and hence the actual current through the n-type TFTs 32, 21 (T3, T2) and LED 20 during the drive period again. Since the current source 31,33,35 is no longer connected to the parasitic (column) capacitance 25, charging of this latter capacitance 25 no longer influences the speed of the programming phase. At the end of the (short) programming phase the current source 31,33,35 is disabled by disabling p-type TFTs 31, 33 (T1, T4) and the same current is supplied to LED 20 by subsequently enabling n-type TFTs 32, 21 (T3, T2).

FIG. 3 shows a first possible embodiment of the voltage-current converter 35, which is realized her by means of a resistor 36. During the programming phase a voltage V in register 15 results in a constant current through the resistor 36.

The voltage-current converter circuit of FIG. 3 is fast due to the voltage programming. However not all spread is removed as the threshold voltage variation and mobility variation of transistors 21 (T2) cause the voltages stored on capacitors 24 (C) to show spread, which influences the current through resistor 36. during programming. Moreover the value of the resistor 36 may show some spread too, resulting in spread of driving current through the LEDs 20.

This has been overcome in the embodiment of FIG. 4 where the VI-converter function is done by capacitor 37. The input current now is defined in a dynamic way: during the programming phase a programming voltage is provided at column 7 having a ramp dV/dt associated with the wanted programming current. Since the capacitor 37 isolates the DC voltages at its two nodes, there is no influence of T2 spread. This embodiment is fast. Even if the voltage across the column (transmission) line is not yet fully settled, due to its transmission-line nature, the input current is better defined.

In one embodiment a buffer amplifier with low-ohmic output impedance generates the ramping voltage. For instance the column driver 15 internally generates a ramping voltage by means of a constant current generator which charges a capacitor, followed by a buffer amplifier with low-ohmic output impedance. This amplifier drives the column line 7. In another embodiment the data line 7 is directly charged by a constant current source. With the large parasitic column line capacitance 25, a ramping voltage is generated and a small fraction (determined by capacitors 25,37) of the constant current will be used for charging capacitor 37, hence for programming the pixel circuit.

More generally the circuit of FIG. 4 may be realized as a so-called DC blocking circuit, containing a capacitive element and further circuitry to r signal processing, e.g. to amplify (or if necessary weaken) the charging current.

Several variations are possible within the scope of the invention. For instance a realization with bipolar transistors is also feasible. In practical circuits more transistors/switches might be added to improve circuit behavior, like additional transistors, switches for charging/pre-charging the capacitors, kickback compensation etc.

Also the idea is not limited to switched mirror pixel circuits

The protective scope of the invention is not limited to the embodiments described. The invention resides in each and every novel characteristic feature and each and every combination of features. Reference numerals in the claims do not limit the protective scope of these claims. The use of the verb “to comprise” and its conjugations does not exclude the presence of elements other than those stated in the claims. The use of the article “a” or “an” preceding an element does not exclude the presence of a plurality of such elements.

1. A display device comprising pixels at the area of crossing electrodes, each pixel comprising at least a current adjusting circuit based on a memory element, a connection point of the adjusting circuit being connectable in series with a luminescent element and comprising voltage-current converting means at the area of a pixel for adjusting current through the luminescent element between a column electrode and a connection point of the memory element.

2. A display device as claimed in claim 1, the voltage-current converting means comprising a DC blocking circuit between the column electrode and the connection point of the memory element.

3. A display device as claimed in claim 2, the voltage-current converting means comprising a capacitance between the column electrode and the connection point of the memory element.

4. A display device as claimed in claim 3, the device further comprising a programmable voltage ramp generator.

5. A display device as claimed in claim 1, the voltage-current converting means comprising a resistor between the column electrode and the connection point of the memory element.

6. A display device as claimed in claim 1, characterized in that the luminescent element comprises an organic LED or a polymer LED.
